(19) United States
(12) Patent Application Publication
(10) Pub. No.: US 2010/0118125 A1
(43) Pub. Date: May 13, 2010

(54) METHOD AND APPARATUS FOR GENERATING THREE-DIMENSIONAL (3D) IMAGE DATA

(75) Inventor: Hyun-soo PARK, Seoul (KR)

Correspondence Address: North Star Intellectual Property Law, PC, P.O. Box 34688, Washington, DC, 20043, US

(73) Assignee: Samsung Electronics Co., Ltd., Suwon-si (KR)

(21) Appl. No.: 12/612,017

(22) Filed: Nov. 4, 2009

(30) Foreign Application Priority Data
Nov. 7, 2008 (KR) 10-2008-0110491

(51) Int. Cl. H04N 13/02; G06K 9/00

(52) U.S. Cl. 348/46; 382/154; 382/285; 382/300; 348/E13.074

(57) ABSTRACT

A method of generating three-dimensional (3D) image data from first and second image data obtained by photographing the same subject at different points of time, the method including generating third image data by adjusting locations of pixels in the second image data so that the second image data corresponds to the first image data, and generating the 3D image data based on a relationship between the third image data and the first image data.

### CROSS-REFERENCE TO RELATED APPLICATION

This application claims the benefit of Korean Patent Application No. 10-2008-0110491, filed on Nov. 7, 2008, in the Korean Intellectual Property Office, the disclosure of which is incorporated herein in its entirety by reference.

### BACKGROUND OF THE INVENTION

1. Field of the Invention

An aspect of the present invention relates to a method and apparatus for generating image data, and more particularly, to a method and apparatus for generating three-dimensional (3D) image data.

2. Description of the Related Art

Today, advances in information and communication technology have led to wide spread use of three-dimensional (3D) image technology. The 3D image technology assigns information regarding depth to a two-dimensional (2D) image, thereby expressing a more realistic image.

The eyes of a human being are spaced a predetermined distance apart in the horizontal direction, and thus, a 2D image seen with the left eye is different from that seen with the right eye. Such a phenomenon is referred to as a binocular parallax. The human brain blends the two different 2D images together to generate a 3D image that is a perspective and realistic representation of a subject being viewed.

In order to provide a 3D image, 3D image data is obtained by assigning depth information to 2D image data, or transforming the 2D image data into the 3D image data.

### SUMMARY OF THE INVENTION

An aspect of the present invention provides a method and apparatus for generating image data.

According to an aspect of the present invention, there is provided a method of generating three-dimensional (3D) image data from first and second image data, wherein the first and second image data is obtained by photographing a same object, the method including generating third image data by adjusting locations of pixels in the second image data so that the second image data corresponds to the first image data; and generating three-dimensional image data based on a relationship between the third image data and the first image data.

According to another aspect of the present invention, the generating of the third image data may include determining a predetermined region of the first image data as a search block; searching the second image data for a corresponding block, where similarity between the coordinates of a corresponding block and the search bock have a value equal to or greater than a threshold; generating transformation information by using coordinates of the search block and coordinates of the corresponding block, where the transformation information represents a relationship between coordinates of a first pixel which is included in the first image data and coordinates of a second pixel which is included in the second image data and corresponds to the first pixel; and changing values of the pixels in the second image data, based on the transformation information.

According to another aspect of the present invention, the changing of the values of the pixels in the second image data may include changing a value of a third pixel based on the transformation information to a value of the second pixel, where the third pixel is included in the second image data and has the same coordinates as the first pixel.

According to another aspect of the present invention, if the second pixel is a sub pixel which has the coordinates corresponding to a decimal place, the changing of the values of the pixels in the second image data may include calculating the value of the second pixel by interpolating values of a plurality of pixels adjacent to the second pixel.

According to another aspect of the present invention, the determining of the predetermined region of the first image data as a search block may include dividing at least one of the first image data and the second image data into a plurality of regions; and determining at least one search block in each of the regions.

According to another aspect of the present invention, the searching of the second image data for a corresponding block may include searching for the corresponding block in a search region of the second image data, which is located within a distance less than or equal to a threshold distance from the search block.

According to another aspect of the present invention, the coordinates of the first pixel may include an x-coordinate indicating the distance between a reference pixel and the first pixel in the horizontal direction and a y-coordinate indicating the distance between the reference pixel and the first pixel in the vertical direction. The transformation information may include at least one of first information representing the relationship among the coordinates of the second pixel and the x-coordinate and the y-coordinate; second information representing the relationship between the coordinates of the second pixel and the product of the x-coordinate and the y-coordinate; and DC offset information (i.e., the transformation information may include, the first information, the second information or the DC offset information and combination thereof).

According to another aspect of the present invention, the first image data may be obtained by photographing the subject at a first point of time with a photographing device, and the second image data may be obtained by photographing the subject at a second point of time with the photographing device.

According to another aspect of the present invention, an aperture value of the photographing device at the first point of time may be different from that at the second point of time.

According to another aspect of the present invention, a focal value of the photographing device at the first point of time may be different from that at the second point of time.

According to another aspect of the present invention, there is provided an apparatus for generating three-dimensional (3D) image data from first and second image data that are obtained by photographing the same subject, the apparatus including a first generator generating third image data by adjusting locations of pixels in the second image data so that the second image data corresponds to the first image data; and a second generator generating three-dimensional image data based on a relationship between the third image data and the first image data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A-1B illustrate image data obtained using a photographing device according to an embodiment of the present invention;

FIGS. 2A-2C illustrate a process of generating third image data, according to an embodiment of the present invention;

FIG. 3 illustrates an example of code used to search for a corresponding block, according to an embodiment of the present invention;

FIG. 4 is a graph illustrating a method of calculating the coordinates of a corresponding block, according to an embodiment of the present invention;

FIG. 5 illustrates an example of a method of moving pixels included in second image data, according to an embodiment of the present invention;

FIG. 6 illustrates an example of code used for changing the value of a pixel by using the method of FIG. 5, according to an embodiment of the present invention;

FIG. 7 is a block diagram of an apparatus for generating image data according to an embodiment of the present invention; and

FIG. 8 is a flowchart illustrating a method of generating image data, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, exemplary embodiments of the present invention will be described in greater detail with reference to the accompanying drawings.

Information on the distance between a subject and a camera is needed to generate three-dimensional (3D) image data from two-dimensional (2D) image data. An example of such information is depth information that represents the distance between a subject indicated by each of the pixels constituting 2D image data and a camera.

The depth information may be obtained according to one of the following three methods.

First, depth information may be obtained by analyzing the shape of a captured image of a subject. However, this method is not available since a method or apparatus for analyzing the shape of a captured image of a subject has yet to be placed on the market.

Second, depth information may be obtained by analyzing at least two pieces of 2D image data that is obtained by photographing the same subject at different angles. A photographing device, e.g., a camera, should have a plurality of optical systems having different optical paths in order to photograph the same subject at different angles. However, since optical systems are expensive, it is inefficient for the photographing device to include two or more optical systems.

Third, 3D image data may be obtained by analyzing two or more pieces of 2D image data that are obtained by photographing the same subject. For example, the paper entitled, “Simple Range Cameras based on Focal Error” (A. Pentland, S. Scherock, T. Darrell, and B. Girod), discloses a method of obtaining depth information by analyzing an image that is in focus and an image that is out of focus. For example, depth information may be obtained by photographing the same subject two or more times while changing a focal or aperture value of a photographing device, and analyzing the obtained two or more pieces of 2D image data. In this paper, Equation 1 as shown below is used for obtaining depth information from two or more pieces of 2D image data. However, Equation 1 is just an example of an equation for obtaining 3D image data from two or more pieces of 2D image data, and the aspects of the present invention are not limited thereto.

$${d}_{0} = \frac{fD}{D - f - 2 {krf}_{number}} , \qquad Equation 1$$

wherein f denotes a focal distance of the lens of a camera, D denotes the distance between the camera and an image plane in the middle of the lens, and r denotes the radius of a blurred portion of a subject that is out of focus. Also, k denotes a transformation constant and f_{number} denotes the numeral value of the focal distance f, which is calculated by dividing the focal distance f by an aperture value of the lens. The other values, except for the radius r in Equation 1, are related to physical conditions of the camera, and thus, can be obtained simultaneously while photographing the subject. Thus, depth information may be obtained by obtaining the radius value r from a captured image.

The above method is effective when two or more pieces of image data can be obtained at the same point of time. However, two or more pieces of image data can be actually obtained at the same point of time only when two or more cameras are used or when a camera having two or more optical systems is used. In particular, even if the same subject is photographed several times for a short period of time, the location of the subject may be changed in image data due to fine vibration caused by movement of the subject or shaking of the hands of a user. In this case, correct depth information cannot be obtained. Thus, when the location of the subject is not the same in two or more pieces of image data, the location of the subject needs to be corrected.

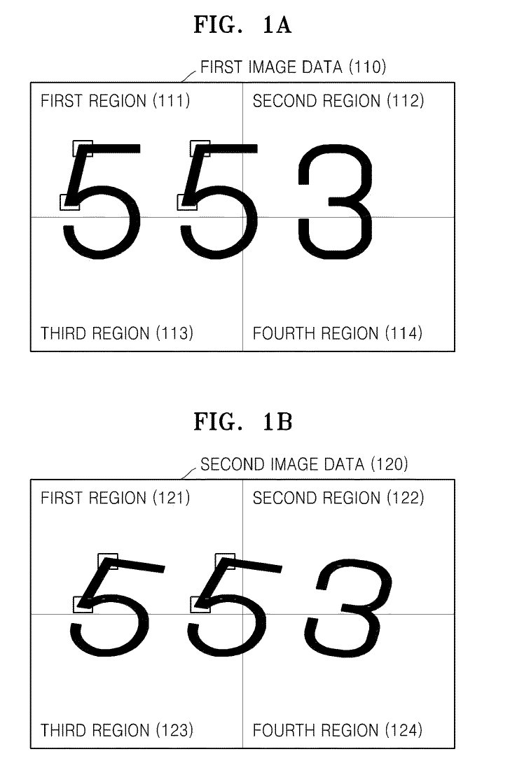

FIGS. 1A and 1B illustrate image data obtained using a photographing device according to an embodiment of the present invention. In particular, FIGS. 1A and B respectively illustrate first image data 110 and second image data 120 that is obtained by photographing the same subject with the same photographing device, e.g., a camera. For convenience of explanation, it is assumed that the first image data 110 is captured at a first point of time and the second image data 120 is captured at a second point of time. Alternatively, the first and second image data 110 and 120 may be captured while changing a focal or aperture value of the photographing device. That is, a focal or aperture value used in capturing the first image data 110 may be different from that used in capturing the second image data 120.

Referring to FIGS. 1A and 1B, the number 553 is photographed by the photographing device but the location of the number 533 in the first image data 110 is different from that in the second image data 120 due to vibrations, e.g., shaking of the hands of a user. If depth information is calculated according to Equation 1, without correcting the location of the number 553, then a calculation error may occur. Thus, the first image data 110 and the second image data 120 need to be corrected to correspond to each other by moving pixels constituting the second image data 120. As discussed throughout the specification, the first image data 110 and the second image data 120 corresponding to each other indicate that the pixels with the same coordinates in the first and second image data 110 and 120 represent the same portion of the subject.

For example, if both a pixel with the coordinates (1,1) in the first image data 110 and a pixel with the coordinates (1,1) in the second image data 120 indicate ‘m’, then these pixels are considered as corresponding to each other. When all pixels in the first image data 110 respectively correspond to those in the second image data 120, the first image data 110 and the second image data 120 are considered as corresponding to each other.

Image data obtained by adjusting the locations of the pixels in the second image data 120, so that the second image data 120 may correspond to the first image data 110, will be hereinafter referred to as ‘third image data’.

The locations of the pixels in the second image data 120 may be precisely adjusted by dividing the second image data 120 into several regions and individually moving the pixels in the several regions. Although in FIGS. 1A and 1B, each of the first image data 110 and the second image data 120 is divided into four regions, the aspects of the present invention are not limited in terms of the total number of regions or a method of dividing image data into several regions.

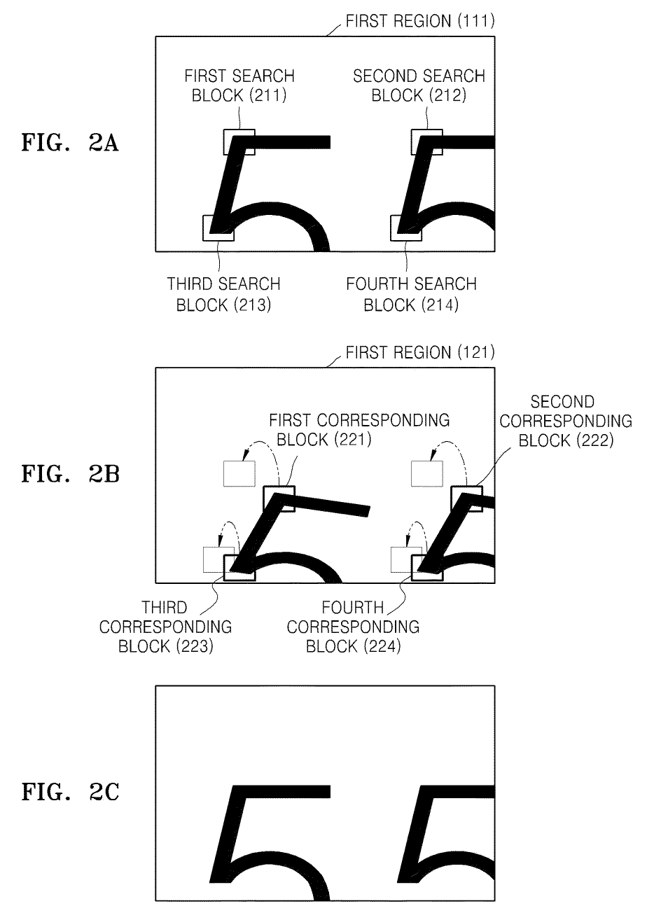

FIGS. 2A-2C illustrate a process of generating third image data, according to an embodiment of the present invention. In particular, FIG. 2A illustrates a first region 111 of the first image data 110 of FIG. 1A, and FIG. 2B illustrate a first region 121 of the second image data 120 of FIG. 1B. The process of FIGS. 2A-2C will now be described based on the first region 111 but the process may also be applied to the other second to fourth regions 112 to 114 of the first image data 110 illustrated in FIG. 1A.

In the first region 111, first through fourth search blocks 211 to 214 are determined. Each of the first through fourth search blocks 211 to 214 may include at least one pixel.

The first to fourth search blocks 211 to 214 may be determined in various ways. For example, specific locations on the first region 111 may be determined as the first through fourth search blocks 211 to 214. Otherwise, the first through fourth search blocks 211 to 214 may be determined to include pixels that show a large change in value. In order to search for pixels that show a large change in value, an edge signal is detected from pixels in the first region 111 and a pixel, in which an edge signal has a value greater than a threshold, is selected from among the pixels in the first region 111.

The locations of the pixels in the first region 111 may be expressed using coordinates on two or more axes. It is assumed that in the first region 111, the horizontal and vertical directions are respectively represented by the X-axis and the Y-axis. The coordinates of a pixel are expressed in the form of (x-coordinate, y-coordinate), where the x-coordinate indicates the distance between a pixel and a reference point on the X-axis and the y-coordinate indicates the distance between the pixel and the reference point on the Y-axis. In this case, the reference point is located at a left lower end of the first region 111 and the coordinates of a pixel on the reference point are (0,0).

In FIGS. 2A-2C, it is assumed that the coordinates of the first search block 211 are (x1,y1), the coordinates of the second search block 212 are (x2,y2), the coordinates of the third search block 213 are (x3,y3) and the coordinates of the fourth search block 214 are (x4,y4). After the first to fourth search blocks 211 to 214 are determined, blocks that are most similar to them are searched for in the second image data 120.

Referring to FIG. 2B, in the second image data 120, a first corresponding block 221 is most similar to the first search block 211, a second corresponding block 222 is most similar to the second search block 212, a third corresponding block 223 is most similar to the third search block 213, and a fourth corresponding block 224 is most similar to the fourth search block 214.

Then, the locations of the pixels in the first region 121 are adjusted using the relationships between the coordinates of the first to fourth search blocks 211 to 214 and their respective coordinates of the first to fourth corresponding blocks 221 to 224.

Similarly, the locations of pixels in the second region 122 to the fourth region 124 are adjusted. FIG. 2C illustrates third image data obtained by adjusting the locations of all the pixels in the second image data 120. Referring to FIG. 2C, the third image data corresponds to the first image data 110. A method of adjusting the location of a pixel will be described in detail with reference to FIG. 4 later.

After the third image data is obtained, depth information is obtained using the relationship between the third image data and the first image data. In this case, Equation 1 may be used.

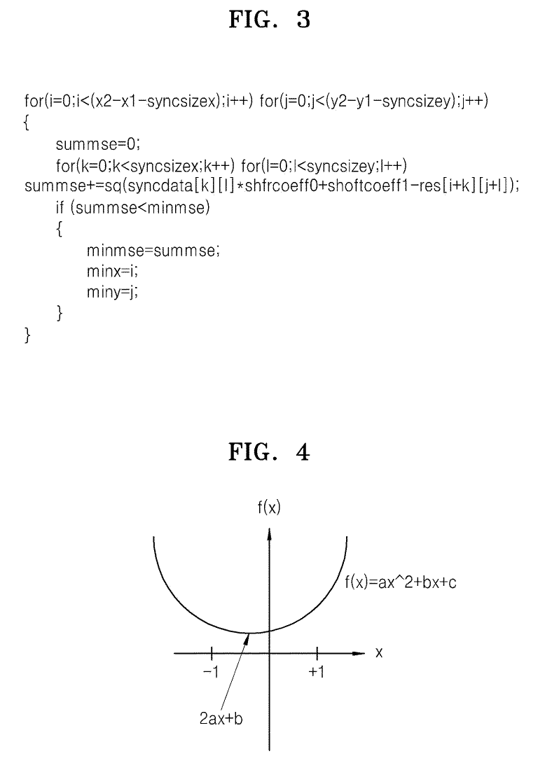

FIG. 3 illustrates an example of code used to search for a corresponding block, according to an embodiment of the present invention.

First, the parameters used in the code of FIG. 3 will be described.

Parameters ‘x1’ and ‘x2’ are x-coordinates of a search region. The search region is included in the second image data 120 of FIG. 1B and is used for searching for a corresponding block. The corresponding block may be searched for in the entire second image data 120 but is preferably searched for only in a region that is located within a distance less than or equal to a threshold distance from a search block since, in general, the differences between the coordinates of the search block and the coordinates of the corresponding block are not large.

Similarly, parameters ‘y1’ and ‘y2’ are y-coordinates of the search region. According to the code of FIG. 3, the search region corresponds to the inside of a quadrangle having vertexes with coordinates (x1,y1), (x1,y2), (x2,y1) and (x2,y2).

Variables ‘syncsizex’ and ‘syncsizey’ respectively denote the horizontal and vertical lengths of the search block. For example, if ‘syncsizex’=2, ‘syncsizey’=3, and the horizontal and vertical lengths of a pixel are 1, then this indicates that the search block includes six pixels.

A parameter ‘summse’ indicates a mean square error (MSE), which denotes the difference between data values of the search block and a current block. It is assumed that the search block consists of four pixels with values respectively of 1, 2, 1, and 2. Also, it is assumed that the current block consists of four pixels and the values of the four pixels are 1, 1, 1, and 2.

In order to calculate the MSE, first, the differences between the values of pixels in the search block and the current block are calculated.

Next, the obtained differences are multiplied by themselves.

Lastly, the multiplication results are added together. Either the root of the addition result or the addition result itself is used as the MSE.

According to the above description, MSE=(1−1)²+(2−1)²+(1−1)²+(2−2)²=4

A parameter ‘syncdata’ indicates the data value of the search block. For example, the parameter ‘syncdata’ may denote the values of the pixels constituting the search block or the sum thereof.

A parameter ‘res’ indicates the data value of the current block.

A parameter ‘shftcoeff0,1’ is a coefficient for correcting the difference between the brightness or saturation of the first image data 110 and the second image data 120.

A parameter ‘minmse’ is the MSE of the corresponding block.

Parameters ‘minx’ and ‘miny’ are x and y coordinates of the corresponding block.

The code of FIG. 3 will now be described based on the above parameters.

The ‘for’ statement at the first line of the code allows the corresponding block to be searched for. By using this ‘for’ statement, the search region may be assigned and the corresponding block may be searched for by calculating the degree of similarity between the coordinates of the search block and the current block while moving the current block by one pixel within the search region.

The ‘for’ statement in the body of the code allows the MSE of the current block to be calculated.

The ‘if’ statement in the last part of the code indicates the location of the corresponding block and allows the MSE of the corresponding block to be calculated.

FIG. 4 is a graph illustrating a method of calculating the coordinates of a corresponding block, according to an embodiment of the present invention.

Although the coordinates of the corresponding block may be calculated using the code of FIG. 3, the integral fractions of the coordinates of the corresponding block can be calculated but the decimal fractions thereof cannot be calculated. FIG. 4 illustrates a method of precisely calculating not only the integral fractions of the coordinates of the corresponding block but also the decimal fractions thereof, according to an embodiment of the present invention.

In the method of FIG. 4, first, the coordinates of the corresponding block are calculated using the code of FIG. 3. If the corresponding block is searched for, the difference between the data values of the corresponding block and a search block is calculated. In FIG. 4, this difference corresponds to an MSE but the aspects of the present invention are not limited thereto.

In this case, the integral coordinates of the corresponding block are calculated.

Next, a coefficient of a function f(x) of FIG. 4 is determined using the difference between the data values of the corresponding block and the search block, the difference between the data values of a block to the right side of the corresponding block and the search block, and the difference between the data values of a block to the left side of the corresponding block and the search block.

Hereinafter, for convenience of explanation, it is assumed that each of the search blocks and the corresponding blocks includes only one pixel and the x-coordinate of the corresponding block detected using the code of FIG. 3 is 10. Also, it is assumed that the value of a pixel having an x-coordinate of 10 is 10.5, the value of a pixel having an x-coordinate of 11 is 11, the value of a pixel having an x-coordinate of 9 is 12, and the value of a pixel corresponding to the search block is 10. In this case, a pixel of which x-coordinate is ‘10’ and of which MSE is ‘0’ may be determined as a reference pixel.

In FIG. 4, the function f(x) is a quadratic function and f(x)=ax²+bx+c.

If the coefficient of the function f(x) is calculated by substituting (0,0.5), (1,1), and (−1,2) into the function f(x), then a=1, b=0.5, and c=0.5. Thus, the function f(x) has a minimum value when x=0.25. The coordinates when the function f(x) has the minimum value are equal to those of the corresponding block, and thus, the x-coordinate of the corresponding block is 10.25.

Similarly, the y-coordinate of the corresponding block may be precisely calculated by calculating a coefficient of a function f(y) and calculating the coordinates when the function f(y) has a minimum value.

Although a quadratic polynomial function is used as the function f(x) or f(y) in FIG. 4, a polynomial function of a degree higher than two or functions, other than a polynomial function, may be used.

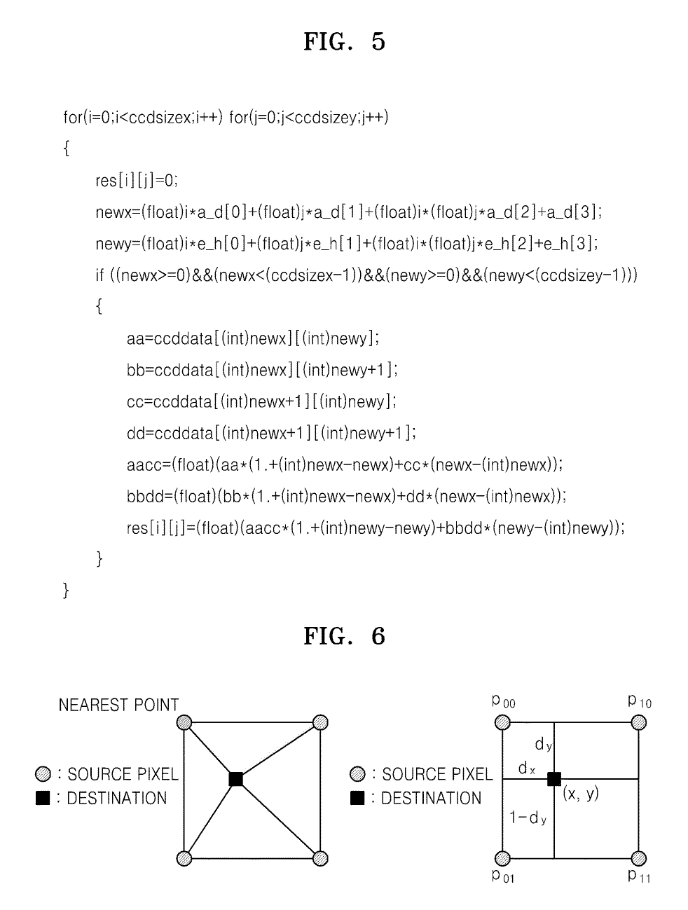

FIG. 5 illustrates an example of code regarding a method of moving pixels included in the second image data 120 of FIG. 1, according to an embodiment of the present invention.

Actually, it is impossible to search for pixels that are most similar to each other by individually comparing the pixels in the first image data 110 of FIG. 1 with those in the second image data 120 of FIG. 1. In the current embodiment, a certain region of the first image data 110 is determined to be a search block, a corresponding block, which is most similar to the search block, is detected from the second image data 120, and the pixels of the second image data 120 are moved according to the relationships between the coordinates of the search block and the corresponding block. As described in the specification, information that represents the relationships between the coordinates of the search block and the corresponding block will be referred to as ‘transformation information’.

First, a case where transformation information represents the linear relationships between the coordinates of the search block and the corresponding block will be described. In this case, two search blocks may be used.

For convenience of explanation, it is assumed that the first search block 211 and the second search block 212 of FIG. 2A are determined as search blocks. After the search blocks are determined, the first corresponding block 221 and the second corresponding block 222 that are respectively most similar to the first search block 211 and the second search block 212 are detected from the second image data 120.

If two search blocks are used, the transformation information may include coefficients expressed in Equation 2.

ax+by=x′

cx+dy=y′ Equation 2

In Equation 2, a, b, c, and d may be calculated by substituting the coordinates of the first search block 211 and the second search block 212 for (x, y) in Equation 2 and substituting the coordinates of the first corresponding block 221 and the second corresponding block 222 for (x′,y′) in Equation 2. Alternatively, a, b, c, and d may be calculated by substituting the coordinates of the first search block 211 and the second search block 212 (x′,y′) in Equation 2 and substituting the coordinates of the first corresponding block 221 and the second corresponding block 222 for (x,y) in Equation 2.

After a, b, c, and d are calculated, all the pixels in the second image data 120 are moved based on Equation 2. For example, if a, b, c, and d are all ‘1’, coordinates (1,1) denote coordinates (2,2) according to Equation 2. Thus, the value of a pixel with the coordinates (1,1) is changed using the value of a pixel with the coordinates (2,2).

Next, a case where the transformation information further includes information regarding a DC offset will be described. In this case, three search blocks may be used.

If the three search blocks are used, the transformation information may include coefficients in Equation 3.

ax+by+c=x′

dx+ey+f=y′ Equation 3

For example, if a, b, c, and d are all ‘1’, coordinates (1,1) denote coordinates (3,3) according to Equation 3. Thus, the value of the pixel with the coordinates (1,1) is changed using the value of a pixel with the coordinates (3,3).

Lastly, a case where the transformation information includes the DC offset, and information regarding the reciprocal effect in which x and y coordinates reciprocally work together in a complex manner (e.g., xy term) will be described. In this case, four search blocks may be used.

When the four search blocks are used, the transformation information may include coefficients expressed in Equation 4.

ax+by+cxy+d=x′

ex+fy+gxy+h=y′ Equation 4

For example, if a, b, c, and d are all ‘1’, coordinates (1,1) denote coordinates (4,4) according to Equation 4. Thus, the value of the pixel with the coordinates (1,1) is changed using the value of a pixel with the coordinates (4,4).

The transformation information illustrated in FIG. 5 is just an exemplary embodiment of the aspects of the present invention and may further include other information, such as the relationship between the x and y coordinates of the corresponding block and a higher order term, e.g., x² or y² of the search block.

Methods of changing the value of a pixel when coordinates calculated using Equation 2, 3 or 4 are integers have been described above. A method of changing the value of a pixel when coordinates calculated using Equation 4 are decimal fractions will now be described using the code of FIG. 5. The value of a sub pixel with decimal coordinates is determined based on the values of neighboring pixels.

In the code of FIG. 5, ‘ccdsizex’ and ‘ccdsizey’ denote either the second image data 120 or a region of the second image data 120. In detail, ‘ccdsizex’ denotes the horizontal length of the second image data 120, which is 2D image data, and ‘ccdsizex’ denotes the vertical length of the second image data 120.

‘newx’ and ‘newy’ denote coordinates calculated using Equation 4.

‘a_d[0] to a_d[3]’ and ‘e_h[0] to e_h[3]’ denote coefficients in Equation 4.

‘res[i][j]’ denotes the value of a pixel with coordinates (i,j).

The code of FIG. 5 will now be described based on the above parameters.

The ‘for’ statement on the first line of the code indicates a region of the second image data 120 and is used to move all the pixels in the second image data 120.

The expression in the ‘for’ statement allows coordinates to be calculated according to Equation 4.

According to an ‘if’ statement, its condition is valid only when the coordinates calculated using Equation 4 are present within the second image data 120.

The ‘if’ statement allows the value res[i][j] of a pixel with coordinates (i,j) to be calculated.

For convenience of explanation, it is assumed that the coordinates (i,j) are (1.2,2.1).

In this case, the value of a pixel with the coordinates (1,2) and the value of a pixel with the coordinates (2,2) are respectively ‘aa’ and ‘bb’, and the value of a pixel with the coordinates (2,3) and the value of a pixel with the coordinates (3,3) are respectively ‘cc’ and ‘dd’.

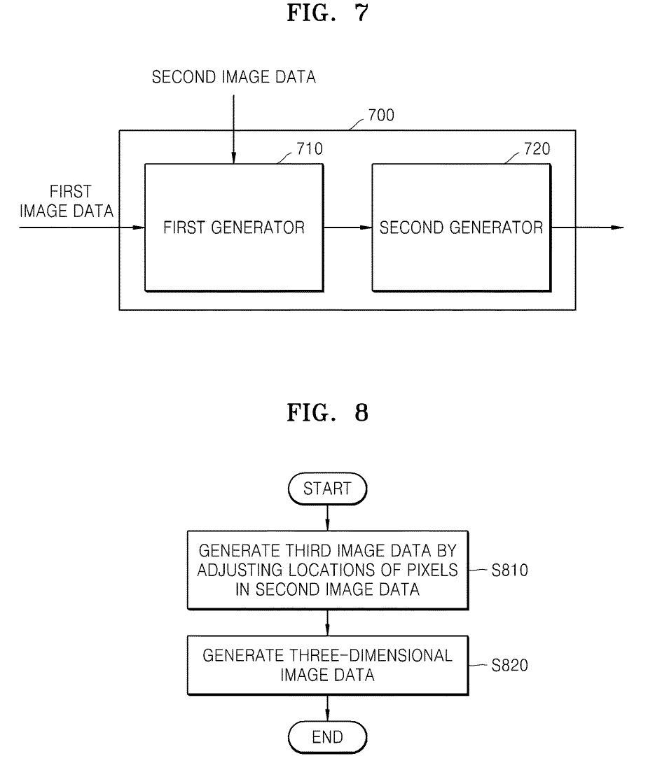

FIG. 6 illustrates a method of changing the value of a pixel by using the code of FIG. 5, according to an embodiment of the present invention.

Referring to FIG. 6, the value of a sub pixel which has a coordinate of decimal place at a destination is to be calculated. For convenience of explanation, it is assumed that the coordinates of the sub pixel are (1,2, 2.1), as described above with reference to FIG. 5. In this case, the coordinates of a pixel P₀₀ are (1,3), the coordinates of a pixel P₁₀ are (2,3), the coordinates of a pixel P₀₁ are (1,2), and the coordinates of a pixel P₁₁ are (2,2).

First, the value of a sub pixel with coordinates (1.2, 3) is calculated using the values of the pixels P₀₀ and P₁₀. Various methods may be used to calculate the value of the sub pixel with the coordinates (1.2, 3) but according to the current embodiment, a method based on the principle that the value of a sub pixel is greatly influenced by the values of pixels adjacent to the sub pixel is used.

For example, the value of the sub pixel with coordinates (1.2, 3) is calculated using the equation: (the value of the pixel P₀₀)×0.8+(the value of the pixel P₁₀)×0.2, and corresponds to a parameter ‘bbdd’ of FIG. 5.

Similarly, the value of a sub pixel with the coordinates (1.2, 2) may be calculated using the values of the pixels P₀₁ and P₁₁. The value of the sub pixel with the coordinates (1.2, 2) may be calculated by the equation: (the value of the pixel P₀₁)×0.8+(the value of the pixel P₁₁)×0.2, and corresponds to a parameter ‘aacc’ of FIG. 5.

Lastly, the value of a sub pixel with coordinates (1.2, 2.1) may be calculated using the values of a sub pixel with coordinates (1.2, 3) and a sub pixel with the coordinates (1.2, 2). The value of the sub pixel with the coordinates (1.2, 2.1) may be calculated by the equation: (the value of the sub pixel with the coordinates (1.2,2))×0.9+(the value of the sub pixel with the coordinates (1.2,3))×0.1, and corresponds to the array ‘res[i][j]’ of FIG. 5

FIG. 7 is a block diagram of an apparatus 700 for generating image data according to an embodiment of the present invention. The apparatus 700 includes a first generator 710 and a second generator 720, and generates 3D image data from first image data and second image data that may be obtained by photographing the same subject with the same photographing device having a single optical system. In this case, the first image data may be obtained at a first point of time and the second image data may be obtained at a second point of time. Also, an aperture value (or a focal value) of the photographing device at the first point of the time may be different from that at the second point of time.

The first generator 710 adjusts the locations of pixels in the second image data so that the second image data corresponds to the first image data. Here, stating that the first image data and the second image data correspond to each other indicates that pixels having the same coordinates in the first image data and the second image data represent image information regarding the same region of the subject.

Although not shown in the drawings, the first generator 710 includes a determination unit, a search unit, a transformation information generation unit, and a change unit.

The determination unit determines a predetermined region of the first image data as a search block. One or more search blocks may be determined. Alternatively, the first image data may be divided into one or more regions, where each of the regions may include one or more search blocks.

The search unit searches the second image data for a corresponding block most similar to the search block. In this case, a region of the second image data, which is located within a distance less than or equal to a threshold distance from the coordinates of the search block, may be determined as a search region, and the corresponding block may be searched for in the search region of the second image data, thereby improving efficiency.

The transformation information generation unit generates transformation information by using the coordinates of the search block and the corresponding block. The transformation information represents the relationship between the coordinates of a first pixel in the first image data and the coordinates of a second pixel, corresponding to the first pixel, in the second image data. That is, the transformation information includes information regarding movement of the locations of the pixels in the second image data so that first image data and the second image data correspond to each other.

The transformation information may further include a DC offset or information regarding the reciprocal effect in which x and y coordinates reciprocally work together in a complex manner.

For example, the transformation information may correspond to the coefficients in Equation 2 when the transformation information represents only the primary relationship between the coordinates of the first and second pixels. The transformation information may correspond to the coefficients in Equation 3 when the transformation information not only represents the primary relationship but also includes the DC offset. The transformation information may correspond to the coefficients in Equation 4 when the transformation information not only represents the primary relationship but also includes the DC offset and the information regarding the reciprocal effect in which the x and y coordinates of the first pixel work together in a complex manner.

The change unit changes the values of the pixels in the second image data based on the transformation information. For convenience of explanation, a certain pixel in the first image data is referred to as the first pixel. The change unit searches for the second pixel by calculating the coordinates of the second pixel that corresponds to the first pixel based on the transformation information of the second pixel. Then, the value of the first pixel is changed using the value of the second pixel.

FIG. 8 is a flowchart illustrating a method of generating image data, according to an embodiment of the present invention.

In operation S810, third image data is generated by adjusting the locations of pixels in second image data so that the second image data corresponds to first image data.

In operation S820, 3D image data is generated using the relationship between the third image data and the first image data.

The above embodiments of the present invention may be embodied as a computer program. The computer program may be stored in a computer readable recording medium, and executed using a general digital computer. Examples of the computer readable medium include a magnetic recording medium (a ROM, a floppy disc, a hard disc, etc.), and an optical recording medium (a CD-ROM, a DVD, etc.).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating three-dimensional (3D) image data from first and second image data that is obtained by photographing a same subject, the method comprising:
generating third image data by adjusting locations of pixels in the second image data so that the second image data corresponds to the first image data; and
generating the three-dimensional image data based on a relationship between the third image data and the first image data.

2. The method of claim 1, wherein the generating of the third image data comprises:
determining a predetermined region of the first image data as a search block;
searching the second image data for a corresponding block, where coordinates between the corresponding block and the search block have a value equal to or greater than a threshold;
generating transformation information by using coordinates of the search block and coordinates of the corresponding block, where the transformation information represents a relationship between coordinates of a first pixel which is included in the first image data and coordinates of a second pixel which is included in the second image data and corresponds to the first pixel; and
changing values of the pixels in the second image data, based on the transformation information.

3. The method of claim 2, wherein the changing of the values of the pixels in the second image data comprises changing a value of a third pixel based on the transformation information to a value of the second pixel, where the third pixel is included in the second image data and has the same coordinates as the first pixel.

4. The method of claim 3, wherein, if the second pixel is a sub pixel which has the coordinates corresponding to a decimal place, the changing of the values of the pixels in the second image data comprises calculating the value of the second pixel by interpolating values of a plurality of pixels adjacent to the second pixel.

5. The method of claim 2, wherein the determining of the predetermined region of the first image data as a search block comprises:
dividing at least one of the first image data and the second image data into a plurality of regions; and
determining at least one search block in each of the regions.

6. The method of claim 2, wherein the searching of the second image data for a corresponding block comprises searching for the corresponding block in a search region of the second image data, which is located within a distance less than or equal to a threshold distance from the search block.

7. The method of claim 2, wherein the coordinates of the first pixel comprise an x-coordinate indicating the distance between a reference pixel and the first pixel in the horizontal direction and a y-coordinate indicating the distance between the reference pixel and the first pixel in the vertical direction,
and the transformation information comprises at least one of:
first information representing the relationship among the coordinates of the second pixel and the x-coordinate and the y-coordinate;
second information representing the relationship between the coordinates of the second pixel and the product of the x-coordinate and the y-coordinate; and
DC offset information.

8. The method of claim 1, wherein the first image data is obtained by photographing the subject at a first point of time with a photographing device, and
the second image data is obtained by photographing the subject at a second point of time with the photographing device.

9. The method of claim 8, wherein an aperture value of the photographing device at the first point of time is different from the aperture value of the photographing device at the second point of time.

10. The method of claim 8, wherein a focal value of the photographing device at the first point of time is different from the focal value of the photographing device at the second point of time.

11. An apparatus for generating three-dimensional (3D) image data from first and second image data that is obtained by photographing the same subject, the apparatus comprising:
a first generator generating third image data by adjusting locations of pixels in the second image data so that the second image data corresponds to the first image data; and
a second generator generating three-dimensional image data based on a relationship between the third image data and the first image data.

12. The apparatus of claim 11, wherein the first generator comprises:
a determination unit determining a predetermined region of the first image data as a search block;
a search unit searching the second image data for a corresponding block, where coordinates between the corresponding block and the search block have a value equal to or greater than a threshold; and
a transformation information generation unit generating transformation information by using coordinates of the search block and coordinates of the corresponding block, where the transformation information represents a relationship between coordinates of a first pixel which is included in the first image data and coordinates of a second pixel which is included in the second image data and corresponds to the first pixel; and
a change unit changing values of the pixels in the second image data, based on the transformation information.

13. The apparatus of claim 12, wherein the change unit changes a value of a third pixel to a value of the second pixel based on the transformation information, where the third pixel is included in the second image data and has the same coordinates as the first pixel.

14. The apparatus of claim 12, wherein, if the second pixel is a sub pixel which has the coordinates corresponding to a decimal place, the change unit comprises a calculation unit that calculates the value of the second pixel by interpolating values of a plurality of pixels adjacent to the second pixel.

15. The apparatus of claim 12, wherein the determination unit divides at least one of the first image data and the second image data into a plurality of regions, and determines at least one search block in each of the regions.

16. The apparatus of claim 12, wherein the search unit searches for the corresponding block in a search region of the second image data, which is located within a distance less than or equal to a threshold distance from the search block.

17. The apparatus of claim 12, wherein the coordinates of the first pixel comprise an x-coordinate indicating the distance between a reference pixel and the first pixel in the horizontal direction and an y-coordinate indicating the distance between the reference pixel and the first pixel in the vertical direction,
and the transformation information comprises at least one of:
first information representing the relationship among the coordinates of the second pixel and the x-coordinate and the y-coordinate;
second information representing relationship between the coordinates of the second pixel and the product of the x-coordinate and the y-coordinate; and
DC offset information.

18. The apparatus of claim 11, wherein the first image data is obtained by photographing the subject at a first point of time with a photographing device, and
the second image data is obtained by photographing the subject at a second point of time with the photographing device.

19. The apparatus of claim 11, wherein an aperture value of the photographing device at the first point of time is different from the aperture value of the photographing device at the second point of time.

20. The apparatus of claim 11, wherein a focal value of the photographing device at the first point of time is different from the focal value of the photographing device at the second point of time.

21. A computer readable recording medium having recorded thereon a computer program for executing the method of claim 1.
